(19) United States
(12) Patent Application Publication
(10) Pub. No.: US 2021/0374613 A1
(43) Pub. Date: Dec. 2, 2021

(54) ANOMALY DETECTION IN HIGH DIMENSIONAL SPACES USING TENSOR NETWORKS

(71) Applicant: X Development LLC, Mountain View, CA (US)

(72) Inventors: Jinhui Wang, Stanford, CA (US); Chase Riley Roberts, Campbell, CA (US)

(21) Appl. No.: 17/331,411

(22) Filed: May 26, 2021

Related U.S. Application Data
(60) Provisional application No. 63/030,164, filed on May 26, 2020.

(51) Int. Cl. G06N 20/00; G06F 17/18

(52) U.S. Cl. CPC G06N 20/00; G06F 17/18

(57) ABSTRACT

Methods and apparatus for anomaly detection in high dimensional spaces using tensor networks. In one aspect, a method for training a machine learning model to classify data points as anomalous or non-anomalous, where the machine learning model includes a tensor network and the training is performed on a plurality of training data points, includes: mapping each training data point to a respective product state in a tensor product space; and training the tensor network using the product states in the tensor product space and a loss function, including determining tensor network parameters that minimize the loss function using gradient descent techniques, wherein the loss function includes a partition function of the tensor network.

### BACKGROUND

Tensors are multi-dimensional generalizations of matrices that can be used to represent multidimensional data, in particular big data that exhibits high variety. For example, tensors are particularly suited for problems in bio- and neuro-informatics or computational neuroscience where data is collected in various forms of large, sparse graphs or networks with multiple aspect and high dimensionality.

Tensor networks are data structures that represent sets of connected core tensors and perform tensor operations such as tensor contractions and reshaping. Tensor networks generalize matrix multiplication to a higher-dimensional setting, and can be applied to a variety of settings. For example, tensor networks can be used to perform machine learning related tasks. Example tasks include compressing neural network weights in order to reduce the amount of computational resources required to implement the neural network without decreasing neural network performance, studying model expressivity as part of a machine learning model design or optimization process, or to parameterize complex dependencies between machine learning model variables.

### SUMMARY

This specification describes techniques for anomaly detection in high dimensional spaces using tensor networks.

In general, one innovative aspect of the subject matter described in this specification can be embodied in a method for training a machine learning model to classify data points as anomalous or non-anomalous, wherein i) the machine learning model comprises a tensor network and ii) the training is performed on a plurality of training data points, the method comprising: mapping each training data point to a respective product state in a tensor product space; and training the tensor network using the product states in the tensor product space and a loss function, comprising determining tensor network parameters that minimize the loss function using gradient descent techniques, wherein the loss function comprises a partition function of the tensor network.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations the loss function comprises a first term and a second term, the first term comprising an inner product of the tensor network applied to a respective product state in the tensor product space.

In some implementations the first term comprises a one-class classification loss.

In some implementations the first term comprises a square of: a logarithm of the inner product minus one.

In some implementations the loss function comprises a first term and a second term, the second term comprising a rectified linear unit function of a logarithm of the partition function.

In some implementations the partition function of the tensor network comprises a Frobenius norm of the tensor network.

In some implementations the loss function comprises a loss function over a size B of batch instances xᵢ and is given by

$${ℒ}_{batch} = \frac{1}{B} {\sum }_{i = 1}^{B} {( log {‖ P Φ ( {x}_{i} ) ‖}_{2}^{2} - 1 )}^{2} + α Re LU ( log {‖ P ‖}_{F}^{2} )$$

where xᵢ represents a training data point, Φ(x₁) represents a product state for training data point xᵢ, and P represents the tensor network.

In some implementations determining tensor network parameters that minimize the loss function using gradient descent techniques comprises computing the loss function according to a contraction order, wherein computing the loss function according to a contraction order comprises: contracting the mapped feature vectors with respective tensors of the tensor network; duplicating a result of the contracting; and attaching the result of the contracting and the duplicated result of the contracting.

In some implementations the tensor network comprises a number of tensors, wherein the number of tensors is equal to a number of feature vectors included in the training data points.

In some implementations the tensor network comprises an input dimension and an output dimension, wherein the output dimension is smaller than the input dimension.

In some implementations the tensor network comprises a Matrix Product Operator tensor network.

In some implementations the Matrix Product Operator tensor network comprises rank-3 and rank-4 tensors.

In some implementations i) each training data point comprises one or more feature vectors and ii) each feature vector comprises one or more channels.

In some implementations mapping each training data point to a respective product state in a tensor product space comprises, for each training data point: applying a fixed map to each feature vector in the training data point to obtain one or more mapped feature vectors, wherein the fixed map maps each feature vector to a vector space with fixed dimension; determining a tensor product of the one or more mapped feature vectors to obtain the respective product state in a tensor product space.

In some implementations a square of a Euclidean norm of the obtained product state is equal to one.

In some implementations the fixed dimension is equal to 2^{C}, where C represents the number of features.

In some implementations under the fixed map, an image of a first feature vector and an image of a second feature vector are orthogonal if i) entries of the first feature vector and second feature vector comprise zero or one and ii) at least one entry of the second feature vector is different to a corresponding entry of the first feature vector.

In some implementations the tensor network projects elements of the tensor product space onto a subspace spanned by the mapped feature vectors.

In some implementations the tensor product space comprises a dimension that is exponential in a number of features represented by the one or more feature vectors.

In some implementations mapping each training data point to a respective product state in a tensor product space comprises mapping each training data point to a surface of a unit hypersphere in the tensor product space.

In some implementations the plurality of training data points comprise non-anomalous data points.

In some implementations training the tensor network using the product states in the tensor product space and a loss function generates a trained tensor network, wherein the trained tensor network classifies a new data point as anomalous or non-anomalous if an inner product of the trained tensor network applied to a respective product state in the tensor product space is above or below a predetermined threshold.

In general, another innovative aspect of the subject matter described in this specification can be embodied in a method for classifying a data point as anomalous or non-anomalous, the method comprising: mapping the data point to a product state in a tensor product space; providing the product state as input to a tensor network, wherein the tensor network has been trained to classify data points as anomalous or non-anomalous using a plurality of training data points and a loss function comprising a partition function of the tensor network; and obtaining an output from the tensor network, wherein the output indicates whether the data point is anomalous or non-anomalous.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations the obtained output comprises an inner product of the tensor network applied to the product state in the tensor product space. In some implementations the output indicates that the data point is anomalous if the inner product of the tensor network applied to the product state in the tensor product space is below a predetermined threshold.

The subject matter described in this specification can be implemented in particular ways so as to realize one or more of the following advantages.

The presently described tensor network anomaly detection system provides an adept anomaly detection model for general data. The incorporation of tensor networks enables the system to exceed the performance and efficiency of classical and deep methods. For example, in some implementations the presently described tensor network anomaly detector system can include a Matrix Product Operator (MPO) tensor network which provides an efficient contraction order that scales linearly with the number of features represented by received input data, despite the MPO tensor network being a linear transformation between spaces with dimensions exponential in the number of features.

In addition, the presently described tensor network anomaly detection system include expressive learned components. The system employs a linear transformation as its main component and subsequently penalizes its Frobenius norm. This transformation has to be performed over an exponentially large feature space for the learned component to be expressive—an impossible task with full matrices. To overcome this difficulty, the system leverages tensor networks as sparse representations of such large matrices.

In addition, the presently described techniques can be widely applied and improve anomaly detection in areas such as fraud prevention, network security, health screening, crime investigation and surveillance monitoring.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example tensor network anomaly detector system.

FIG. 2 is an illustration of an example TNAD embedding layer in tensor network notation.

FIG. 3 shows an example parameterization of a linear transformation implemented by a MPO tensor network in terms of rank-3 and 4 tensors in tensor network notation.

FIG. 4 is an illustration of a TNAD system output in tensor network notation.

FIG. 5 is an illustration of a TNAD training penalty in tensor network notation.

FIG. 6 is an illustration of steps for computing ∥PΦ(x)∥₂² in tensor network notation.

FIG. 7 is an illustration of the form of ∥P∥_{F}² and the resulting network for ∥PΦ(x)∥₂².

FIG. 8 is a flow diagram of an example process for training a machine learning model to classify data points as anomalous or non-anomalous.

FIG. 9 is a flow diagram of an example process for classifying a data point as anomalous or non-anomalous.

FIG. 10 is a flow diagram of an example process for classifying a data point as anomalous or non-anomalous.

Like reference numbers and designations in the various drawings indicate like elements.

### DETAILED DESCRIPTION

### Overview

Anomaly detection includes identifying suspicious points in a dataset that do not conform to a pattern seen in the majority of data. Anomaly detection has many applications ranging from detecting fraud in financial transaction to preventing cyber-attacks on production systems. Whilst anomaly detection is a well-studied area, deep learning with anomaly detection has been lackluster and is very rarely used in production. One reason for this is that machine learning models are typically trained on a training data set of non-anomalous data points and neural networks cannot know what they do not know. In addition, neural networks are not practically integratable, so being able to make claims about the entire state space of inputs is not possible.

To overcome such drawbacks, this specification describes techniques for anomaly detection in high dimensional spaces using tensor networks. Tensor Networks are structures that allow for sparse representations of incredibly large matrices. They have been used in areas such as condensed matter physicists, quantum computing, molecular dynamics, and language modeling. Certain types of linear algebra calculations such as inner products (xAA*x*) and partition functions (tr(A)) can be performed efficiently given certain tensor network structures.

The techniques described herein combine these features to provide a state of the art loss function for training anomaly detection models. The models include tensor networks, e.g., Matrix Product Operators (MPO), with a smaller output dimension than input dimension. The input to the model can be a product state, e.g., the pixels of an input image can be mapped to vectors, and the output of the model is a scalar of the inner product of the tensor network and product state input with itself. To ensure a tight fit around training inliers, a loss term of the partition function of the model is added to penalize its overall tendency to predict normality. This partition function penalty is not possible with neural network approaches.

In other words, Tensor Networks are used to learn a transformation, e.g., a linear transformation, on an exponentially high-dimensional space. Working in such a large space enables the model to be expressive. Because of the structure of the mode, its global behavior on the input space can be gauged, e.g. by its Frobenius norm (F-norm) in the case of a linear transformation. As such, a loss term that penalizes its global tendency to predict normality, e.g. by penalizing the Frobenius norm, can be added to ensure a tight fit around training inliers. This is infeasible in deep learning architectures which do not possess similar measures of their global behavior

For example, let A represent a tensor network model with input dimension M and output dimension N and M>>N, where M is the size of the entire input space and can be exponentially large. Let U represent a matrix of left singular vectors, S represent a diagonal matrix of singular values, and V represent a matrix of right singular values such that A=USV*. Because M>>N, A can only have at most N non-zero singular values.

Let x represent an arbitrary input from the non-anomalous distribution. The prediction output of the model is then xAA*x*. For simplicity it can be assumed that x and U have the same basis. Therefore, xAA*x*=sᵢ where sᵢ represents the ith singular value of A. Therefore, for the basis states that are non-anomalous, their singular values should be positive.

The partition function of A is also equal to tr(A) which is also equal to the sum of the squared singular values. When added to the loss function, this function attempts to suppress all of the singular values to 0. Because of this, for all z that are not from the non-anomalous distribution, i.e., for anomalous z, a trained model with the lowest possible loss will have zAA*z*=0, or approximately equation to zero, e.g., within a predetermined threshold, thus flagging it as an anomaly.

### Example Hardware

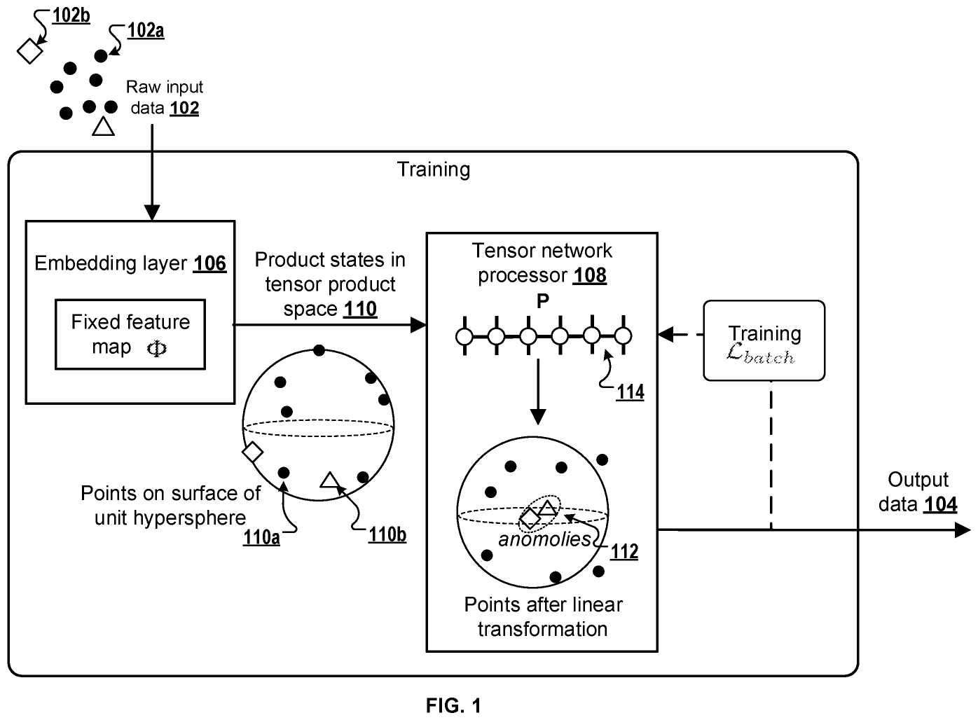

FIG. 1 shows an example tensor network anomaly detection (TNAD) system 100. The system 100 is an example of a system implemented as computer programs on one or more computers in one or more locations, in which the systems, components, and techniques described below can be implemented.

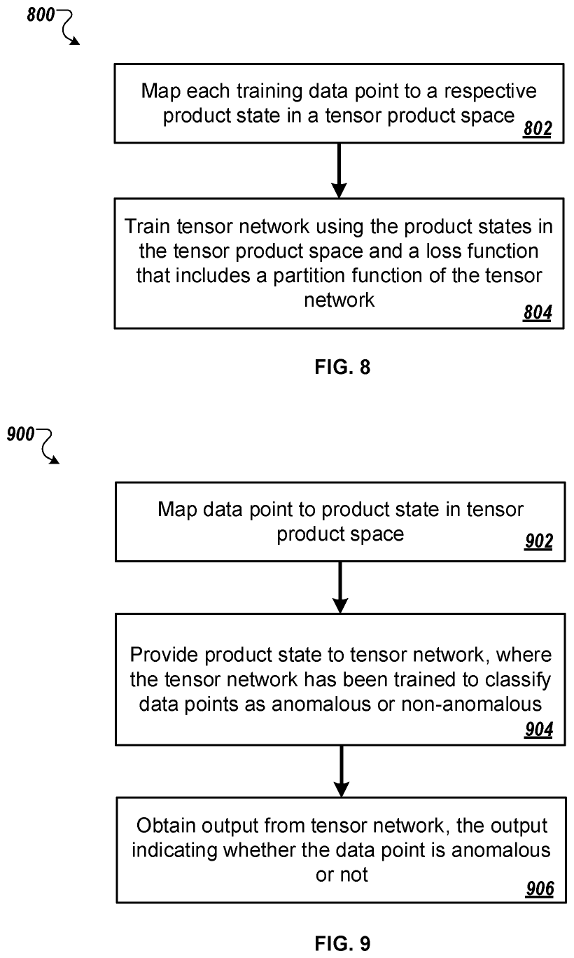

The TNAD system 100 is configured to receive as input raw data, e.g., data 102. The type of data received by the TNAD system can vary. For example, the data 102 can include image data or tabular data. The data 102 can include non-anomalous data, e.g., data point 102a, or anomalous data, e.g., data point 102b. The TNAD system 100 is configured, through training, to process received data 102 and to provide as output data indicating whether the processed input data is anomalous or not, e.g., output data 104. An example process for training a machine learning model to classify data points as anomalous or non-anomalous is described below with reference to FIG. 8.

The TNAD system 100 includes an embedding layer 106 in data communication with a tensor network processor 108, e.g., a tensor processing unit. For convenience, embedding layer 106 and tensor network processor 108 are illustrated as separate entities, however in some implementations the embedding layer 106 may be included in the tensor network processor 108.

The embedding layer 106 is configured to receive the raw input data points 102 and to map the raw input data points to respective product states in a tensor product space 110. To map a received input data point, the embedding layer 106 applies a fixed feature map Φ to the input data point to map the data point onto a surface of a unit hypersphere in a vector space V. For example, input data point 102a can be mapped to point 110a on the surface of a unit hypersphere in the vector space V. The vector space V can have a dimension that is equal to a number of features N represented by the input data point. Example fixed feature maps Φ are described in more detail below with reference to Matrix Product Operator tensor networks.

The embedding layer 106 is configured to provide the product states in the tensor product space 110 to the tensor network processor 108. The tensor network processor 108 includes a tensor network and is configured to receive the product states in the tensor product space 110 and apply a parameterized linear transformation P:V→W to the product states in the tensor product space 110 to generate transformed product states.

Parameters of the linear transformation can be adjusted, through training on a set of training data inputs, from initial values to trained values. For example, the TNAD system 100 can implement a batch gradient descent algorithm using a loss function parameterized by the linear transformation parameters. To obtain a tight fit around inliers, the Frobenius norm of P is penalized during training. The Frobenius norm of P is given below in Equation (1).

$${‖ P ‖}_{F}^{2} = t r ( {P}^{T} P ) = {\sum }_{i , j} {\vert {P}_{i j} \vert}^{2} \qquad ( 1 )$$

In Equation (1), ∥P∥_{F}² represents the Frobenius norm of P and Pᵢⱼ represent the matrix elements of P with respect to a basis. Since the Frobenius norm of P is the sum of squared singular values of P, it captures the total extent to which the model is likely to deem an instance as normal. Ultimately, such a spectral property reflects the overall behavior of the model, rather than its restricted behavior on the training set.

After training, the action of the linear transformation P causes non-anomalous data points to be mapped close to the surface of a hypersphere in vector space W. The vector space W can have an arbitrary radius. Anomalous data points are mapped close to the origin, e.g., anomalous data point 110b is mapped to a position 112 close to the origin of the hypersphere. To accommodate the possible predominance of outliers, the dimension of the vector space W can have a smaller exponential scaling with N so that dim W<<dim V for P to have a large null-space. P can then be understood as a projection that annihilates the subspace spanned by outliers.

The TNAD system 100 is configured to apply a decision function to the transformed product states to obtain respective values that indicate whether the corresponding raw data inputs are anomalous or not. For example, the TNAD system 100 can apply the decision function given by Equation (2) below.

[symbol]

(x)=∥PΦ(x)∥₂² (2)

In Equation (2), x represents a raw data input, Φ(x) represents the output of the embedding layer 106, e.g., a product state obtained after the fixed feature map Φ is applied to the raw data input x, P represents the linear transformation applied by the tensor network to Φ(x), and ∥PΦ(x)∥₂² represents the squared L2-norm of PΦ(x), e.g., the squared L2-norm of a transformed product state obtained after the linear transformation P is applied to the product state Φ(x).

In some implementations larger values of the decision function indicate a larger likelihood that the corresponding input data point x is non-anomalous. In some implementations values above a predetermined threshold can indicate that the corresponding data points are non-anomalous data points and values below the predetermined threshold can indicate that the corresponding data points are anomalous data points. The predetermined threshold can be selected and/or adjusted based on the particular anomaly detection task being performed by the system 100 and a target accuracy.

### Example Tensor Network: Matrix Product Operator Tensor Network

In some implementations the tensor network processor 108 can include a Matrix Product Operator (MPO) tensor network. A MPO tensor network is a tensor network where each tensor has two external, uncontracted indices as well as two internal indices contracted with neighboring tensors as in a chain. Formally, an MPO tensor network is a factorization of a tensor with N covariant and N contravariant indices into a contracted product of smaller tensors, each carrying one of the original contravariant and covariant indices each, as well as bond indices connecting to the neighboring factor tensors. A diagrammatic form 114 of a MPO tensor network is shown in FIG. 1.

In these implementations the raw input data 102 can be data points from an input space [symbol] . For example, the input space can be [0,1]^{N} for data inputs representing (flattened) grey-scale images or [symbol] ^{N} for data inputs representing tabular data, where N represents the number of features. Given a predetermined map Φ: [symbol] → [symbol] ⁹, where p ϵ [symbol] is a parameter that represents the physical dimension, the embedding layer 106 is configured to pass the data input x=(x₁, . . . , x_{N}) ϵ [symbol] is through a fixed feature map Φ: [symbol] →V=⊗ⱼ₌₁^{N} [symbol] ^{p} defined by

Φ(x)=ϕ(x₁)⊗ϕ(x₂)⊗ . . . ⊗ϕ(x_{N}) (3)

where ⊗ⱼ₌₁^{N} is a p^{N}-dimensional vector space and therefore a very large vector space.

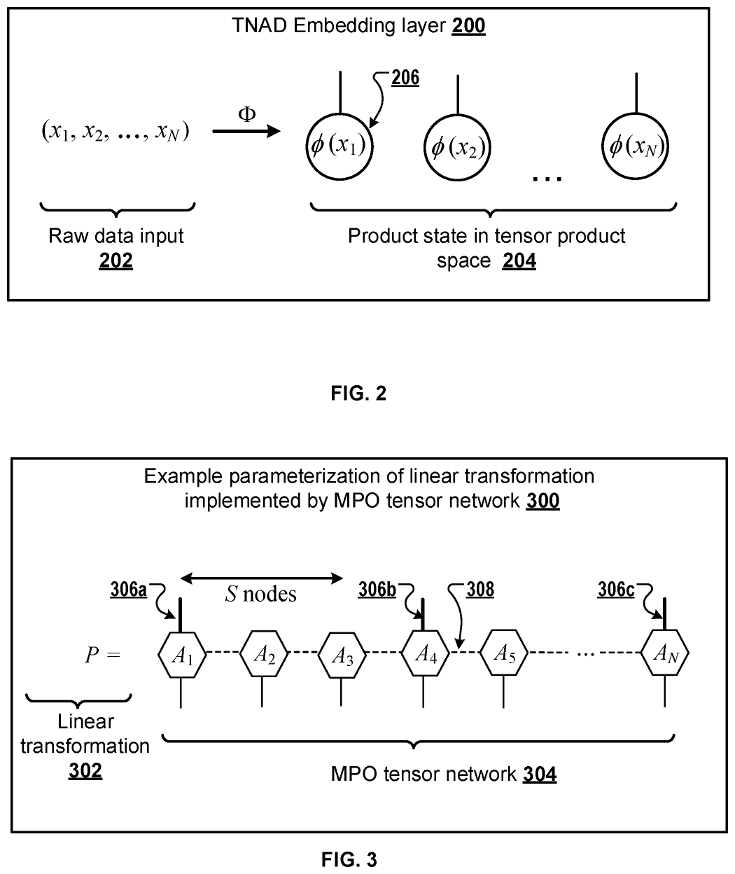

FIG. 2 is an illustration of an example TNAD embedding layer 200 in tensor network notation. A raw data input 202, e.g., x=(x₁, . . . , x_{N}), is processed by the TNAD embedding layer 200 through application of the feature map Φ described above. Application of the feature map Φ produces a product state in tensor product space 204, e.g., Φ(x) as given in Equation (3) above. In FIG. 2, each tensor in the product state 204 is represented by a respective circle, e.g., circle 206 represents tensor Φ(x₁). The single lines emanating from each circle indicate that each tensor is a vector, e.g., the product state is a tensor product of vectors.

Returning to FIG. 1, the map ϕ can be chosen to satisfy ∥ϕ(y)∥₂²=1 for all y ϵ [symbol] such that ∥Φ(x)∥₂²=Πᵢ₌₁^{N}∥ϕ(xᵢ)∥₂² for all x ϵ [symbol] , implying that the fixed map Φ applied by the embedding layer 106 maps all data points to the unit hypersphere in the vector space V. For example, in some implementations the map ϕ can be chosen to be a 2k-dimensional trigonometric embedding ϕ_{trig}: [symbol] → [symbol] ^{2k} defined in Equation (4) below.

$${ϕ}_{trig} ( x ) = \frac{1}{√ k} ( cos ( \frac{π}{2} x ) , sin ( \frac{π}{2} x ) , … cos ( \frac{π}{{2}^{k}} x ) , sin ( \frac{π}{{2}^{k}} x ) ) \qquad ( 4 )$$

In some implementations, e.g., implementations where the raw data inputs include grey-scale images, the physical dimension and parameter k can be chosen to equal p=2k=2. In these implementations, since ϕ_{trig}(0), ϕ_{trig}(1) are the two standard basis vectors e₁, e₂ of [symbol] ²= [symbol] ^{p}, the set of binary-valued images [symbol] ={x ϵ [symbol] :xᵢ ϵ {0,1} ∀1≤i≤N} is mapped to the standard basis of V. Intuitively, the values 0 and 1 correspond to extreme cases in a feature (which reflects the pixel brightness in this case) so ϕ(0), ϕ(1) are devised to be orthogonal for maximal separation. Now, for any x, y ϵ [symbol] , since the inner product [symbol] Φ(x), Φ(y) [symbol] satisfies [symbol] Φ(x), Φ(y) [symbol] =Π_{1≤i≤N} [symbol] ϕ(xᵢ), ϕ(yᵢ) [symbol] , the fixed map Φ is highly sensitive to each individual feature—flipping a single pixel value from 0 to 1 would lead to an orthogonal vector after Φ. In essence, [symbol] then contains all extreme representatives of the input space [symbol] , which can be seen to be images of highest contrast, and is mapped by Φ to the standard basis of V for maximal separation. The squared F-norm of the subsequent linear transformation P performed by the tensor network processor 108 then obeys Equation (5) below.

$${‖ P ‖}_{F}^{2} = {\sum }_{x ∈ ℬ} {‖ P Φ ( x ) ‖}_{2}^{2} \qquad ( 5 )$$

Recalling that ∥PΦ(x)∥₂² is the value of the TNAD system decision function (given in Equation (2)) on an input x, ∥P∥_{F}² therefore confers the meaning of the total degree of normality predicted by the TNAD system on these extreme representatives—apt since images with the best contrast should be the most distinguishable.

As another example, in some implementations the map ϕ can be chosen to be a p-dimensional Fourier embedding ϕ_{four}: [symbol] → [symbol] ^{p} defined component-wise (indexing from 0) in Equation (6) below.

$${ϕ}_{four}^{j} ( x ) = \frac{1}{p} \vert {\sum }_{k = 0}^{p - 1} {e}^{2 π i k ( \frac{p - 1}{p} \times - \frac{j}{p} )} \vert \qquad ( 6 )$$

This map has a period of

$$\frac{p}{p - 1}$$

and satisfies the following property. On

$$[ 0 , \frac{p}{p - 1} ] ,$$

the i-th value in

$$\{ 0 , \frac{1}{p - 1} , … , \frac{p - 2}{p - 1} , 1 \}$$

is mapped to the i-th standard basis vector of [symbol] ^{p}. Thus,

$$\{ 0 , \frac{1}{p - 1} , … , \frac{p - 2}{p - 1} , 1 \}$$

and its periodic-equivalents are deemed as extreme cases and a similar analysis follows as before.

Fixed feature maps Φ constructed using the example maps ϕ described above segregate points close in the L²-norm of the input space [symbol] by mapping inputs into the exponentially-large space V, buttressing the subsequent linear transformation P performed by the tensor network processor 108.

After the embedding layer 106 passes the data input x=(x₁, . . . , x_{N}) ϵ [symbol] through the fixed feature map Φ: [symbol] →V=⊗ⱼ₌₁^{N} [symbol] ^{p}, a tensor

$${P}_{{i}_{1} … {i}_{q}}^{{j}_{1 … } {j}_{N}} \text{:} V \to W = {⊗}_{j = 1}^{q} {ℝ}^{p}$$

is learned, where

$$q = ⌊ \frac{N - 1}{s} ⌋ + 1$$

for some parameter S ϵ [symbol] referred to as the spacing.

FIG. 3 shows an example parameterization 300 of the linear transformation P 302 implemented by a MPO tensor network processor 108 in terms of rank-3 and 4 tensors in tensor network notation. In FIG. 3, each tensor is represented by a respective hexagon. The lines emanating from each hexagon represent the tensor indices. For example, tensors A₁, A₂, A₃, A₅, A_{N} each have three emanating lines and are therefore rank-3 tensors. Tensor A₄ has four emanating lines and is therefore a rank-4 tensor.

The MPO tensor network 304 has an outgoing leg, e.g., legs 306a-c, every S nodes, beginning from the first. The legs 306a-c have dimension p while the dashed legs, e.g., leg 308, have dimension b, which is a parameter known as the bond dimension. Intuitively, the dashed legs are responsible for capturing correlations between features, for which a larger value of b is desirable. In tensor indices the parameterization of P is given by Equation (7) below.

$${P}_{{i}_{1} … {i}_{q}}^{{j}_{1} … {j}_{N}} = {( {A}_{1} )}_{{i}_{1} {k}_{1}}^{{j}_{1}} {( {A}_{2} )}_{{k}_{2}}^{{k}_{1} {j}_{2}} {( {A}_{3} )}_{{k}_{3}}^{{k}_{2} {j}_{3}} … {( {A}_{S + 1} )}_{{i}_{2} {k}_{S + 1}}^{{k}_{S} {j}_{S + 1}} {( {A}_{S + 2} )}_{{i}_{2} {k}_{S + 2}}^{{k}_{S + 1} {j}_{S + 2}} \qquad ( 7 )$$

In Equation (7) Einstein's summation convention is adopted and A₁, . . . , A_{N} represent the parameterizing low-rank tensors.

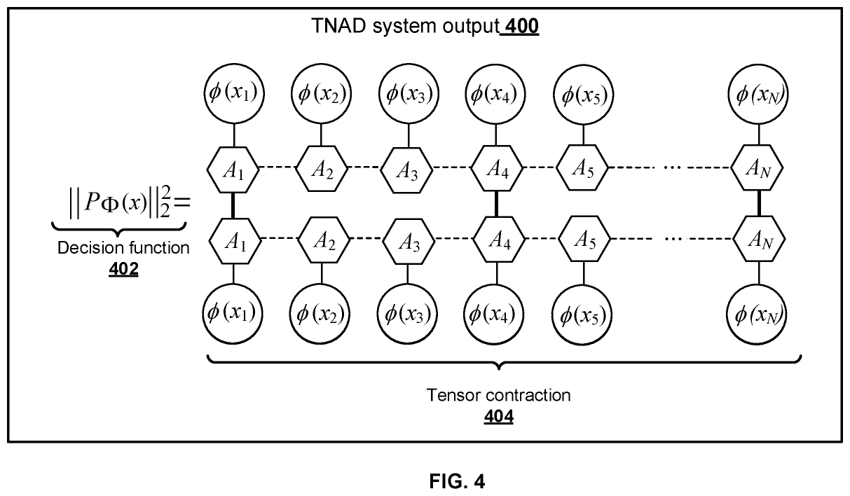

Returning to FIG. 1, the TNAD system 100 generates a system output through computation of the decision function given in Equation (2) above. FIG. 4 is an illustration 400 of a TNAD system output in tensor network notation. FIG. 4 shows the squared L2-norm of PΦ(x) 402 as a tensor contraction 404 of PΦ(x) with itself, e.g., a contraction of the MPO tensor network 304 shown in FIG. 3 applied to the product state 204 shown in FIG. 4 with itself.

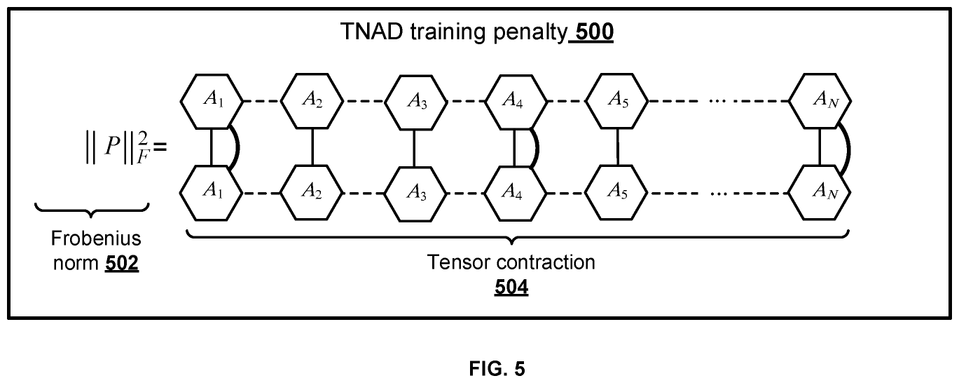

As described above, the TNAD system 100 penalizes the Frobenius norm of P during training. FIG. 5 is an illustration 500 of a TNAD training penalty. FIG. 5 shows the Frobenius norm of P 502 as a tensor contraction 504 of P with itself.

Combining the above, the loss function used to train the TNAD system 100 over a batch of B instances xᵢ is given by Equation (8) below.

$${ℒ}_{batch} = \frac{1}{B} {\sum }_{i = 1}^{B} {( log {‖ P Φ ( {x}_{i} ) ‖}_{2}^{2} - 1 )}^{2} + α Re LU ( log {‖ P ‖}_{F}^{2} ) \qquad ( 8 )$$

In Equation (8) a represents a hyperparameter that controls the trade-off between TNAD's fit around training points and its overall tendency to predict normality. In words, P only sees normal instances during training which it tries to map to vectors on a hypersphere of radius fc, but it is simultaneously deterred from mapping other unseen instances to vectors of non-zero norm due to the ∥P∥_{F}² penalty. The logarithms are taken to stabilize the optimization by batch gradient descent since the value of a large tensor network can fluctuate by a few orders of magnitude with each descent step even with a tiny learning rate. The ReLU function is applied to the F-norm penalty to avoid the trivial solution of P=0.

To improve the efficiency of calculating the loss function given by Equation (8), the TNAD system 100 can determine an efficient order for multiplying the tensors—a process known as contraction—to compute ∥PΦ(x)∥₂² and ∥P∥_{F}². Though different contraction schemes lead to the same result, they may have vastly different time complexities, for which the simplest example is the quantity ∥Aν∥₂²=ν^{T} (A^{T} A)ν=(Aν)^{T} (Aν) for some matrix A and vector ν—the first bracketing involves an expensive matrix product while the second bypasses it. The time-complexity of a contraction between two nodes can be read off a tensor network diagram as the product of the dimensions of all legs connected to the two nodes, without double-counting. Though searching for the optimal contraction order of a general network is NP-hard, an efficient contraction order that scales linearly with N for MPO is known—despite being a linear transformation between spaces with dimensions exponential in N.

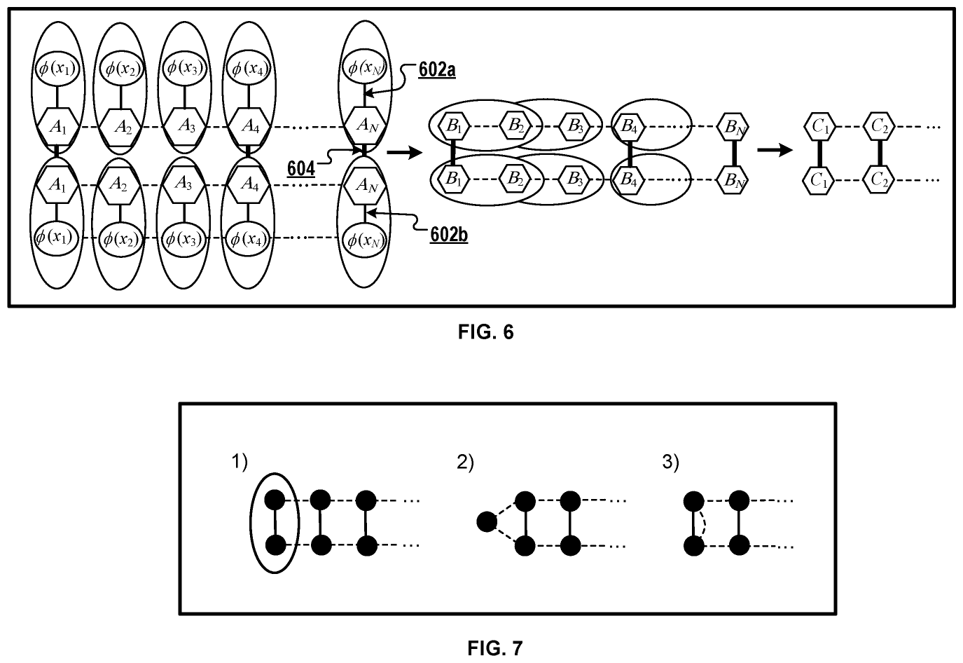

The initials steps in computing ∥PΦ(x)∥₂² are vertical contractions of the vertical legs, e.g., legs 602a, 602b, followed by right-to-left horizontal contractions along segments between consecutive boldface legs, e.g., leg 604, as shown in FIG. 6. In some implementations, only the bottom half of the network is contracted before it is duplicated and attached to itself. This process can be parallelized. The form of ∥P∥_{F}² and the resulting network for ∥PΦ(x)∥₂² is illustrated in FIG. 7, which can be computed efficiently by repeated zig-zag contractions. The overall time complexities of computing ∥PΦ(x)∥₂² and are

$$O ( N {b}^{2} ( b + p ) ( \frac{P}{S} + 1 ) ) and$$

$$O ( N {b}^{3} p ( \frac{P}{S} + 1 ) ) ,$$

respectively, where only the former is needed during prediction. Meanwhile, the overall space complexity of TNAD is

$$O ( N {b}^{2} p ( \frac{P}{S} + 1 ) ) .$$

### Programming the Hardware: An Example Process for Training a Machine Learning Model to Classify Data Points as Anomalous or Non-Anomalous

FIG. 8 is a flow diagram of an example process 800 for training a machine learning model to classify data points as anomalous or non-anomalous. The machine learning model includes a tensor network, e.g., a Matrix Product Operator tensor network. In some implementations the tensor network includes a number of tensors that is equal to a number of feature vectors included in multiple training data points used to train the machine learning model. For convenience, the process 800 will be described as being performed by a system of one or more computing devices located in one or more locations. For example, a tensor network anomaly detector, e.g., the system 100 of FIG. 1, appropriately programmed in accordance with this specification, can perform the process 800.

The system maps each training data point of the multiple training data points to a respective product state in a tensor product space, e.g., by mapping each training data point to a surface of a unit sphere in the tensor product space (step 802). In some implementations the multiple training data points can include only non-anomalous (normal) data points, since in most settings normal examples are typically readily available while anomalies tend to be rare in production environments. Each training data point includes one or more feature vectors, where each feature vector includes one or more channels. In some implementations the tensor product space includes a dimension that is exponential in the number of features represented by the one or more feature vectors.

To map a training data point to a respective product state in the tensor product space, the system applies a fixed map to each feature vector in the training data point to obtain one or more mapped feature vectors, where the fixed map maps each feature vector to a vector space with fixed dimension. In some implementations the fixed dimension is equal to 2^{C}, where C represents the number of features. In some implementations, under the fixed map, an image of a first feature vector and an image of a second feature vector are orthogonal if i) entries of the first feature vector and second feature vector comprise zero or one and ii) at least one entry of the second feature vector is different to a corresponding entry of the first feature vector.

The system then determines a tensor product of the one or more mapped feature vectors to obtain the respective product state in a tensor product space. In some implementations a square of a Euclidean norm of the obtained product state is equal to one.

The system trains the tensor network using the product states in the tensor product space and a loss function (step 804). The loss function includes a partition function of the tensor network. In some implementations the loss function includes a first term and a second term, where the first term includes an inner product of the tensor network applied to a respective product state in the tensor product space. In some implementations the first term includes a one-class classification loss. In some implementations the first term includes a square of: a logarithm of the inner product minus one. In some implementations the second term includes a rectified linear unit function of a logarithm of the partition function, for example where the partition function of the tensor network includes a Frobenius norm of the tensor network. In some implementations the loss function is a loss function over a size B of batch instances xᵢ and is given by Equation (8) above, which is repeated below.

$${ℒ}_{batch} = \frac{1}{B} {\sum }_{i = 1}^{B} {( log {‖ P Φ ( {x}_{i} ) ‖}_{2}^{2} - 1 )}^{2} + α Re LU ( log {‖ P ‖}_{F}^{2} ) \qquad ( 8 )$$

In equation (8) xᵢ represents a training data point, Φ(x₁) represents a product state for training data point xᵢ, P represents the action of the tensor network, e.g., the linear transformation implemented by the tensor network, and a represents a hyperparameter that controls the trade-off between a fit around training points and a tendency to predict normality.

To train the tensor network the system determines tensor network parameters that minimize the loss function using gradient descent techniques. In some implementations the system computes the loss function according to a contraction order. For example the system can contract the mapped feature vectors with respective tensors of the tensor network, duplicate a result of the contracting, and attach the result of the contracting and the duplicated result of the contracting, as illustrated with reference to FIG. 6.

The trained tensor network can classify a new data point as anomalous or non-anomalous if an inner product of the trained tensor network applied to a respective product state in the tensor product space is above or below a predetermined threshold.

Programming the Hardware: An Example Process for Classifying a Data Point as Anomalous or Non-Anomalous

FIG. 9 is a flow diagram of an example process 900 for classifying a data point as anomalous or non-anomalous. For convenience, the process 900 will be described as being performed by a system of one or more computing devices located in one or more locations. For example, a tensor network anomaly detector, e.g., the system 100 of FIG. 1, appropriately programmed in accordance with this specification, can perform the process 900.

The system maps the data point to a product state in a tensor product space, e.g., by mapping the data point to a surface of a unit hypersphere in the tensor product space (step 902). The data point can include one or more feature vectors, where each feature vector includes one or more channels. In some implementations the tensor product space has a dimension that is exponential in a number of features represented by the one or more feature vectors.

To map the data point to a respective product state in the tensor product space, the system can apply a fixed map to each feature vector in the data point to obtain one or more mapped feature vectors, where the fixed map maps each feature vector to a vector space with fixed dimension. In some implementations the fixed dimension is equal to 2^{C}, where C represents the number of features. Under the fixed map, an image of a first feature vector and an image of a second feature vector are orthogonal if i) entries of the first feature vector and second feature vector comprise zero or one and ii) at least one entry of the second feature vector is different to a corresponding entry of the first feature vector. The system then determines a tensor product of the one or more mapped feature vectors to obtain the product state in a tensor product space. In some implementations a square of a Euclidean norm of the obtained product state is equal to one.

The system provides the product state as input to a tensor network (step 904). In some implementations the tensor network includes a number of tensors equal to a number of feature vectors included in the data point. In some implementations the tensor network can be a Matrix Product Operator tensor network, e.g., including rank-3 and rank-4 tensors. The tensor network has been trained to classify data points as anomalous or non-anomalous using a plurality of training data points and a loss function comprising a partition function of the tensor network, e.g., according to example process 800 of FIG. 8.

The system obtains an output from the tensor network, where the output indicates whether the data point is anomalous or non-anomalous (step 906). In some implementations the obtained output includes an inner product of the tensor network applied to the product state in the tensor product space. In these implementations the output can indicate that the data point is anomalous if the inner product of the tensor network applied to the product state in the tensor product space is below a predetermined threshold.

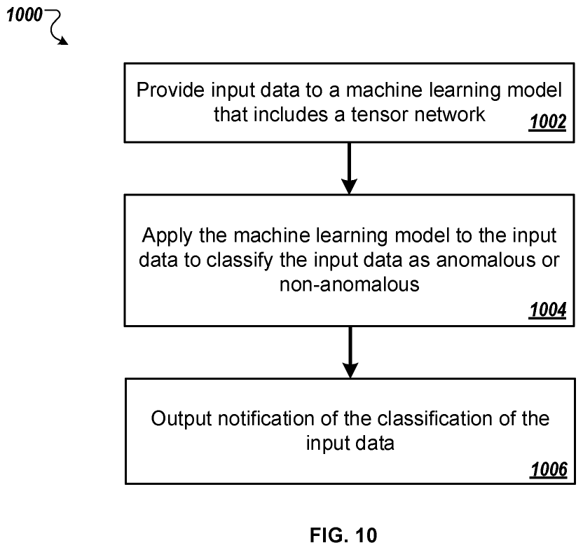

FIG. 10 is a flow diagram of a second example process 1000 for classifying a data point as anomalous or non-anomalous. The example process 1000 can be combined or used in conjunction with the systems and techniques described above with reference to FIGS. 1-9. For convenience, the process 1000 will be described as being performed by a system of one or more computing devices located in one or more locations. For example, a tensor network anomaly detector, e.g., the system 100 of FIG. 1, appropriately programmed in accordance with this specification, can perform the process 1000.

The system provides input data to a machine learning model comprising a tensor network (step 1002). The tensor network includes a set of connected core tensors and is configured to perform tensor operations, e.g., as described above with reference to FIGS. 1, 8 and 9. The tensor network has been trained to classify data points as anomalous or non-anomalous using a plurality of training data points and a loss function, e.g., as described above with reference to FIGS. 8 and 9. The system applies the machine learning model to the input data to classify the input data as anomalous or non-anomalous (step 1004). The system outputs a notification of the classification of the input data (step 1006).

Embodiments and all of the functional operations described in this specification may be implemented in digital electronic circuitry, or in computer software, firmware, or hardware, including the structures disclosed in this specification and their structural equivalents, or in combinations of one or more of them.

Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. A method for training a machine learning model to classify data points as anomalous or non-anomalous, wherein the machine learning model comprises a tensor network the method comprising:
providing a plurality of training data points to the machine learning model;
mapping each training data point of the plurality of training data points to a respective product state in a tensor product space; and
training the tensor network using the product states in the tensor product space and a loss function, wherein training the tensor network comprises determining tensor network parameters that minimize the loss function using gradient descent techniques, wherein the loss function comprises a partition function of the tensor network.

2. The method of claim 1, wherein the loss function comprises a first term and a second term, the first term comprising an inner product of the tensor network applied to a respective product state in the tensor product space.

3. The method of claim 2, wherein the first term comprises a square of: a logarithm of the inner product minus one.

4. The method of claim 1, wherein the loss function comprises a first term and a second term, the second term comprising a rectified linear unit function of a logarithm of the partition function.

5. The method of claim 1, wherein the partition function of the tensor network comprises a Frobenius norm of the tensor network.

6. The method of claim 1, wherein the loss function comprises a loss function over a size B of batch instances xᵢ and is given by
$${ℒ}_{batch} = \frac{1}{B} {\sum }_{i = 1}^{B} {( log {‖ P Φ ( {x}_{i} ) ‖}_{2}^{2} - 1 )}^{2} + α Re LU ( log {‖ P ‖}_{F}^{2} )$$
where xᵢ represents a training data point, Φ(x₁) represents a product state for training data point xᵢ, P represents the tensor network, and α represents a hyper parameter that controls a trade-off between a fit around training points and a tendency to predict normality.

7. The method of claim 1, wherein determining tensor network parameters that minimize the loss function using gradient descent techniques comprises computing the loss function according to a contraction order, wherein computing the loss function according to a contraction order comprises:
contracting the mapped feature vectors with respective tensors of the tensor network;
duplicating a result of the contracting; and
attaching the result of the contracting and the duplicated result of the contracting.

8. The method of claim 1, wherein the tensor network comprises a number of tensors, wherein the number of tensors is equal to a number of feature vectors included in the training data points.

9. The method of claim 1, wherein the tensor network comprises an input dimension and an output dimension, wherein the output dimension is smaller than the input dimension.

10. The method of claim 1, wherein the tensor network comprises a Matrix Product Operator tensor network, optionally wherein the Matrix Product Operator tensor network comprises rank-3 and rank-4 tensors.

11. The method of claim 1, wherein
i) each training data point comprises one or more feature vectors,
ii) each feature vector comprises one or more channels, and
iii) mapping each training data point to a respective product state in a tensor product space comprises, for each training data point:
applying a fixed map to each feature vector in the training data point to obtain one or more mapped feature vectors, wherein the fixed map maps each feature vector to a vector space with fixed dimension, optionally wherein the fixed dimension is equal to 2^{C}, where C represents the number of features; and
determining a tensor product of the one or more mapped feature vectors to obtain the respective product state in a tensor product space, optionally wherein a square of a Euclidean norm of the obtained product state is equal to one.

12. The method of claim 11, wherein under the fixed map, an image of a first feature vector and an image of a second feature vector are orthogonal if i) entries of the first feature vector and second feature vector comprise zero or one and ii) at least one entry of the second feature vector is different to a corresponding entry of the first feature vector.

13. The method of claim 11, wherein the tensor product space comprises a dimension that is exponential in a number of features represented by the one or more feature vectors.

14. The method of claim 1, wherein mapping each training data point to a respective product state in a tensor product space comprises mapping each training data point to a surface of a unit hypersphere in the tensor product space.

15. The method of claim 1, wherein the plurality of training data points comprise non-anomalous data points.

16. The method of claim 1, wherein training the tensor network using the product states in the tensor product space and a loss function generates a trained tensor network, wherein the trained tensor network classifies a new data point as anomalous or non-anomalous if an inner product of the trained tensor network applied to a respective product state in the tensor product space is above or below a predetermined threshold.

17. A method for classifying a data point as anomalous or non-anomalous, the method comprising:
mapping the data point to a product state in a tensor product space;
providing the product state as input to a tensor network, wherein the tensor network has been trained to classify data points as anomalous or non-anomalous using a plurality of training data points and a loss function comprising a partition function of the tensor network; and
obtaining an output from the tensor network, wherein the output indicates whether the data point is anomalous or non-anomalous.

18. The method of claim 17, wherein the obtained output comprises an inner product of the tensor network applied to the product state in the tensor product space, optionally wherein the output indicates that the data point is anomalous if the inner product of the tensor network applied to the product state in the tensor product space is below a predetermined threshold.

19. The method of claim 17, wherein the tensor network comprises a number of tensors, wherein the number of tensors is equal to a number of feature vectors included in the data point.

20. A system comprising one or more computers and one or more storage devices storing instructions that are operable, when executed by the one or more computers, to cause the one or more computers to perform operations comprising training a machine learning model to classify data points as anomalous or non-anomalous, wherein the machine learning model comprises a tensor network, the training comprising:
providing a plurality of training data points to the machine learning model;
mapping each training data point of the plurality of training data points to a respective product state in a tensor product space; and
training the tensor network using the product states in the tensor product space and a loss function, wherein training the tensor network comprises determining tensor network parameters that minimize the loss function using gradient descent techniques, wherein the loss function comprises a partition function of the tensor network.

21. A computer-readable storage medium comprising instructions stored thereon that are executable by a processing device and upon such execution cause the processing device to perform operations comprising training a machine learning model to classify data points as anomalous or non-anomalous, wherein the machine learning model comprises a tensor network, the training comprising:
providing a plurality of training data points to the machine learning model;
mapping each training data point of the plurality of training data points to a respective product state in a tensor product space; and
training the tensor network using the product states in the tensor product space and a loss function, wherein training the tensor network comprises determining tensor network parameters that minimize the loss function using gradient descent techniques, wherein the loss function comprises a partition function of the tensor network.

22. A system comprising one or more computers and one or more storage devices storing instructions that are operable, when executed by the one or more computers, to cause the one or more computers to perform operations comprising:
mapping the data point to a product state in a tensor product space;
providing the product state as input to a tensor network, wherein the tensor network has been trained to classify data points as anomalous or non-anomalous using a plurality of training data points and a loss function comprising a partition function of the tensor network; and
obtaining an output from the tensor network, wherein the output indicates whether the data point is anomalous or non-anomalous.

23. A computer-readable storage medium comprising instructions stored thereon that are executable by a processing device and upon such execution cause the processing device to perform operations comprising:
mapping the data point to a product state in a tensor product space;
providing the product state as input to a tensor network, wherein the tensor network has been trained to classify data points as anomalous or non-anomalous using a plurality of training data points and a loss function comprising a partition function of the tensor network; and
obtaining an output from the tensor network, wherein the output indicates whether the data point is anomalous or non-anomalous.
